(19) United States
(12) Patent Application Publication
(10) Pub. No.: US 2026/0196218 A1
(43) Pub. Date: Jul. 9, 2026

(54) METHOD AND APPARATUS FOR CONTROLLING WEARABLE DEVICE AND WEARABLE DEVICE

(71) Applicant: Beijing Zitiao Network Technology Co., Ltd., Beijing (CN)

(72) Inventor: Xiaofeng SHU, Beijing (CN)

(21) Appl. No.: 19/443,979

(22) Filed: Jan. 8, 2026

(30) Foreign Application Priority Data
Jan. 9, 2025 (CN) 202510038561.9

(51) Int. Cl. G10L 15/22; G10L 21/0208; H04R 1/10

(52) U.S. Cl. CPC G10L 15/22; G10L 21/0208; H04R 1/10; G10L 2015/223; G10L 2021/02082; H04R 2460/13

(57) ABSTRACT

The disclosure provides a method and apparatus for controlling a wearable device, and a wearable device, and relates to the field of device control. The method for controlling the wearable device includes: acquiring a first voice signal received by a first input end of the wearable device, wherein the first voice signal is a bone conduction signal; acquiring a second voice signal received by a second input end of the wearable device, wherein the second voice signal is a non-bone conduction signal; determining a correlation between the first voice signal and the second voice signal; and controlling the wearable device according to the second voice signal and the correlation between the first voice signal and the second voice signal.

### CROSS-REFERENCE TO RELATED APPLICATIONS

The disclosure is based on and claims the benefit of priority to Chinese Patent Application No. 202510038561.9, filed on Jan. 9, 2025, which is incorporated in its entirety herein by reference.

### TECHNICAL FIELD

The present disclosure relates to the field of device control, and in particular, to a method and an apparatus for controlling a wearable device, a wearable device, a storage medium, and a program product.

### BACKGROUND

Wearable devices such as earphones have already been widely used. However, in real life, a wearer of the wearable device can control the wearable device, but another user can also control the wearable device, so that the wearer is interfered in interaction with the wearable device, thereby influencing the overall experience.

### SUMMARY

According to some embodiments of the present disclosure, there is provided a method for controlling a wearable device, including: acquiring a first voice signal received by a first input end of the wearable device, wherein the first voice signal is a bone conduction signal; acquiring a second voice signal received by a second input end of the wearable device, wherein the second voice signal is a non-bone conduction signal; determining a correlation between the first voice signal and the second voice signal; and controlling the wearable device according to the second voice signal and the correlation between the first voice signal and the second voice signal.

According to further embodiments of the present disclosure, there is provided an apparatus for controlling a wearable device, including: a first voice signal acquisition module configured to acquire a first voice signal received by a first input end of the wearable device, wherein the first voice signal is a bone conduction signal; a second voice signal acquisition module configured to acquire a second voice signal received by a second input end of the wearable device, wherein the second voice signal is a non-bone conduction signal; a correlation determination module configured to determine a correlation between the first voice signal and the second voice signal; and a control module configured to control the wearable device according to the second voice signal and the correlation between the first voice signal and the second voice signal.

According to still further embodiments of the present disclosure, there is provided an apparatus for controlling a wearable device, including: a processor; and a memory coupled to the processor, the processor configured to perform the method for controlling the wearable device of any embodiment of the present disclosure based on instructions stored in the memory.

According to still further embodiments of the present disclosure, there is provided a wearable device, including: the apparatus for controlling the wearable device of any embodiment of the present disclosure; a first input end configured to receive a first voice signal, wherein the first voice signal is a bone conduction signal; and a second input end configured to receive a second voice signal, wherein the second voice signal is a non-bone conduction signal.

According to still further embodiments of the present disclosure, there is provided a non-transitory computer readable storage medium having computer program instructions stored thereon which, when executed by a processor, implementing the method for controlling a wearable device of any embodiment of the present disclosure.

According to still further embodiments of the present disclosure, there is provided a computer program product, including a computer program or instructions which, when executed by a processor, implement the method for controlling a wearable device of any embodiment of the present disclosure.

Other features, aspects, and their advantages of the present disclosure will become apparent from the following detailed description of exemplary embodiments of the present disclosure with reference to the accompanying drawings.

### BRIEF DESCRIPTION OF THE DRAWINGS

The embodiments of the present disclosure are described below with reference to the accompanying drawings. It is to be understood that the accompanying drawings in the following description are directed to only some embodiments of the present disclosure and are not the limitations to the present disclosure. In the drawings:

FIG. 1 illustrates a flow diagram of a method for controlling a wearable device according to some embodiments of the present disclosure;

FIG. 2 illustrates a flow diagram for determining a correlation between the first voice signal and the second voice signal according to some embodiments of the present disclosure;

FIG. 3 illustrates a flow diagram for controlling the wearable device according to some embodiments of the present disclosure;

FIG. 4 illustrates a flow diagram of a method for controlling a wearable device according to still further embodiments of the present disclosure;

FIG. 5 illustrates a flow diagram for controlling an output of voice content in the second voice signal according to some embodiments of the present disclosure;

FIG. 6 illustrates a link diagram of a method for controlling a wearable device according to some embodiments of the present disclosure;

FIG. 7 illustrates a block diagram of an apparatus for controlling a wearable device according to some embodiments of the present disclosure;

FIG. 8 illustrates a block diagram of an apparatus for controlling a wearable device according to further embodiments of the present disclosure;

FIG. 9 illustrates a block diagram of a wearable device according to some embodiments of the present disclosure;

FIG. 10 illustrates a block diagram of an electronic device according to some embodiments of the present disclosure.

It should be understood that the dimensions of various parts shown in the drawings are not necessarily drawn to scale for ease of illustration. The same or similar reference numbers are used throughout the drawings to refer to the same or like parts. Thus, once an item is defined in one drawing, it may not be further discussed in subsequent drawings.

### DETAILED DESCRIPTION

The technical solutions in the embodiments of the present disclosure will be clearly and completely described below with reference to the accompanying drawings in the embodiments of the present disclosure. It is to be understood that the present disclosure may be embodied in various forms and should not be construed as limited to the embodiments set forth herein.

It should be understood that various steps recited in method embodiments of the present disclosure may be performed in a different order, and/or be performed in parallel. Moreover, the method embodiments may include additional steps and/or omit performing the illustrated steps. The scope of the present disclosure is not limited in this respect. Unless specifically stated otherwise, relative arrangement of components and steps, numerical expressions, and numerical values set forth in these embodiments should be construed as merely illustrative, and not limiting the scope of the present disclosure.

The term “including” and variations thereof as used in this disclosure are intended to be open ended terms that include at least the following elements/features, but do not exclude other elements/features, i.e., “including but not limited to”. The term “based on” means “based at least in part on”.

It should be noted that the terms “first”, “second”, and the like in the present disclosure are only used for distinguishing different devices, modules or units, and are not used for limiting the order or interdependence of functions performed by the devices, modules or units. Unless otherwise specified, the terms “first”, “second”, and the like are not intended to imply that the objects as described must be in a given order, either temporally, spatially, in ranking, or in any other way.

It is noted that references to “a/an” or “more” in this disclosure are intended to be illustrative rather than limiting, and that those skilled in the art will appreciate that they should be understood as “one or more” unless the context clearly indicates otherwise.

The names of messages or information exchanged between devices in the embodiments of the present disclosure are for illustrative purposes only, and are not intended to limit the scope of the messages or information.

The user information (including but not limited to user device information, user personal information, etc.) and data (including but not limited to data for analysis, stored data, displayed data, etc.) to which the present disclosure relates are information and data that are authorized by the user or sufficiently authorized by each party, and the collection, use and processing of the relevant data requires compliance with relevant laws and regulations and standards in relevant countries and regions, and corresponding accesses are provided for the user to choose to authorize or deny.

The embodiments of the present disclosure will be described in detail below with reference to the accompanying drawings, but the present disclosure is not limited to these specific embodiments. These particular embodiments below may be combined with each other, and details of the same or similar concepts or processes may not be repeated in some embodiments. Furthermore, in one or more embodiments, the particular features, structures, or characteristics may be combined in any suitable manner as would be apparent to one of ordinary skill in the art from this disclosure.

To implement voice control of a wearable device, it is necessary to first recognize whether a wearer of the wearable device is speaking. In related art, whether the wearer of the wearable device is speaking is determined by detecting an energy magnitude of a bone conduction signal and according to the energy magnitude of the bone conduction signal. However, in some hardware scenarios, there is a situation that the energy of the bone conduction signal is unstable, and therefore, whether the wearer of the wearable device is speaking cannot be accurately recognized according to the energy magnitude of the bone conduction signal, resulting in the occurrence of a situation where the wearable device is mistakenly controlled.

The embodiments of the present disclosure provide a method for controlling a wearable device, capable of accurately controlling the wearable device and reducing the occurrence of false control.

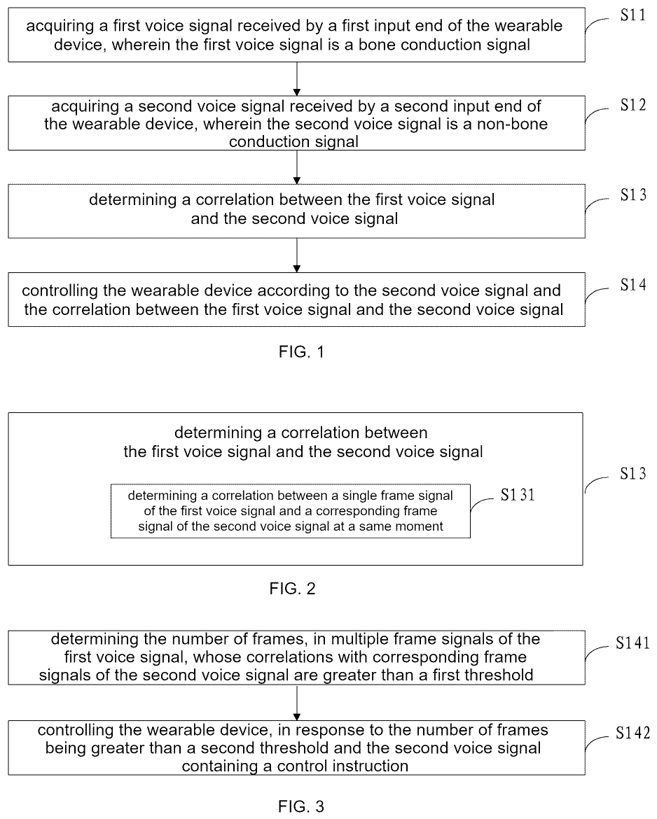

FIG. 1 is a flow diagram of the method for controlling the wearable device according to some embodiments of the present disclosure. As shown in FIG. 1, the method of this embodiment includes: step S11, acquiring a first voice signal received by a first input end of the wearable device, wherein the first voice signal is a bone conduction signal; step S12, acquiring a second voice signal received by a second input end of the wearable device, wherein the second voice signal is a non-bone conduction signal; step S13, determining a correlation between the first voice signal and the second voice signal; and step S14, controlling the wearable device according to the correlation between the first voice signal and the second voice signal, and the second voice signal.

In the above embodiment, whether the wearer of the wearable device is speaking is recognized according to the correlation between the two voice signals, and then the wearable device is controlled according to the second voice signal, so that the wearable device can be controlled with a command of the wearer, thereby improving the experience of the wearer.

The method for controlling the wearable device will be described below in conjunction with specific examples.

The wearable device is, for example, an earphone, a hearing aid, an AR (Augmented Reality) device, a VR (Virtual Reality) device or the like with a bone conduction sensor.

In step S11, the first input end is, for example, a bone conduction microphone, through which a voice signal can be picked up, thereby generating the bone conduction signal. The bone conduction microphone is, for example, a VPU (Voice Pick-up Unit) microphone capable of extracting voice information with high quality in a noisy environment.

Bone conduction is a sound conduction mode, that is, sound is converted into mechanical vibrations with different frequencies, and sound waves are transmitted through the skull, bony labyrinth, inner ear lymph fluid, spiral organ and auditory center of the human body. Compared with a classical sound conduction mode of generating sound waves through a vibrating diaphragm, the bone conduction omits a plurality of sound wave transmission steps, the clear sound restoration can be achieved in the noisy environment, and the sound waves will not influence other people due to diffusion in the air. Therefore, the bone conduction signal is usually the voice signal uttered by the wearer himself.

In step S12, the second input end can receive the non-bone conduction signal, such as an air conduction signal. The second input end is, for example, a normal microphone. The normal microphone is an energy conversion device that converts a sound signal into an electric signal.

In some embodiments, the second input end is one of a directional microphone and a omnidirectional microphone that receives a voice signal with lower energy.

The wearable device may contain three microphones, e.g., the VPU microphone, the directional microphone, and the omnidirectional microphone. The directional microphone is a directional microphone that can accurately capture sound from a specific direction and suppress noise from other directions. The omnidirectional microphone is a multi-directional microphone that can capture sound from multiple directions. Under different scenes, performances of the directional microphone and the omnidirectional microphone are inconsistent, and the microphone with lower energy can be selected as a microphone for subsequent signal processing according to the specific scene. The microphone with lower energy is a microphone with lower noise. The voice signal received by the microphone with lower noise is more convenient and accurate in subsequent processing. In this embodiment, by selecting the non-bone conduction signal, the accuracy of subsequent signal processing can be improved.

In step S13, the correlation between the first voice signal and the second voice signal may be determined, for example, by a correlation algorithm. The correlation algorithm adopted in calculating the correlation between the first voice signal and the second voice signal is not limited in the present disclosure.

Since the bone conduction signal is usually a voice signal of the wearer himself, if the second voice signal also includes the voice signal of the wearer himself, the correlation between the first voice signal and the second voice signal is large, and if the second voice signal does not include the voice signal of the wearer himself, the correlation between the first voice signal and the second voice signal is small.

In order to improve the accuracy of the signal correlation calculation, the method for controlling the wearable device further includes: before determining the correlation between the first voice signal and the second voice signal, AEC (Acoustic Echo Cancellation) processing is performed on the first voice signal and the second voice signal.

AEC technique can reduce or eliminate echo in the voice signal by recognizing and removing an echo component in the voice signal to clarify the voice signal. The AEC algorithm is not limited in this embodiment, and those skilled in the art can perform the Acoustic Echo Cancellation processing on the voice signal using the related AEC algorithm, to improve the definition of the signal, thereby improving the accuracy of subsequent signal correlation judgement.

In step S14, for example, in a case that the correlation between the first voice signal and the second voice signal is greater than a first threshold, it indicates that the wearer is trying to control the wearable device, and the wearable device may be controlled at this time. In a case that the correlation between the first voice signal and the second voice signal is less than or equal to the first threshold, it indicates that the wearer is not speaking, and the wearable device should not be controlled at this time.

For another example, the second voice signal is recognized, and if the second voice signal includes a control instruction, the wearable device is controlled according to the control instruction in a case that the correlation between the first voice signal and the second voice signal is greater than the first threshold.

In the above embodiment, by using the correlation between two types of voice signals, it can be still recognized whether the wearer of the wearable device is speaking even if the energy of the bone conduction signal is low, reducing the occurrence of false control of the device due to inaccuracy of recognition of the single voice signal.

In some embodiments, the speaking state of the wearer of the wearable device can be judged first using the energy of the bone conduction signal, and then the speaking state of the wearer can be judged auxiliarly using the correlation between the two types of voice signals, so that the accuracy of the judgment of the speaking state of the wearer can be improved by combining the two judgment methods.

The processing of the voice signal is a streaming processing, i.e. each voice signal includes a plurality of frame signals, and the correlation of a single frame signal can be calculated. Next, the correlation between the first voice signal and the second voice signal will be introduced in combination with FIG. 2.

FIG. 2 illustrates a flow diagram of determining the correlation between the first voice signal and the second voice signal according to some embodiments of the present disclosure, wherein step S13 includes step S131, and only differences between FIG. 2 and FIG. 1 will be described below, but the same parts will not be repeated.

In step S131, determining the correlation between a single frame signal of the first voice signal and a corresponding frame signal of the second voice signal at a same moment.

For example, the correlation coefficient Γ(Δ, μ) of the frame signal of the μth frequency point in the λth frame of the first voice signal and the frame signal of the μth frequency point in the λth frame of the second voice signal is calculated according to formula (1), wherein λ is a positive integer greater than or equal to 1, and μ is a positive integer greater than or equal to 1.

$$Γ ( λ , μ ) = \frac{{Φ}_{{x}_{1} {x}_{2}} ( λ , μ )}{\sqrt{{Φ}_{{x}_{1} {x}_{1}} ( λ , μ ) {Φ}_{{x}_{2} {x}_{2}} ( λ , μ )}} \qquad ( 1 )$$

wherein

$${Φ}_{{x}_{i} {x}_{j}} ( λ , μ ) = {α}_{s} {Φ}_{{x}_{i} {x}_{j}} ( λ - 1 , μ ) + ( 1 - {α}_{s} ) {Φ}_{{x}_{i}} ( λ , μ ) {Φ}_{j}^{H} ( λ , μ )$$

αₛ is the smoothing parameter, the value of i is 1 or 2, the value of j is 1 or 2, x₁ represents the first voice signal, x₂ represents the second voice signal, H represents the conjugate transpose, Φx₁x₂(λ, μ) is the covariance of the frame signal of the uth frequency point in the λth frame of the first voice signal and the frame signal of the uth frequency point in the λth frame of the second voice signal, and \sqrt{Φx₁x₁(λ,μ) Φx₂x₂ (λ, μ)} represents the auto-covariance of the frame signal of the μth frequency point in the λth frame of the first voice signal and the frame signal of the μth frequency point in the λth frame of the second voice signal.

After the correlation coefficient Γ(Δ, μ) of the frame signal of the uth frequency point in the λth frame of the first voice signal and the frame signal of the μth frequency point in the λth frame of the second voice signal is calculated, the correlation corresponding to each frequency point of each frame signal can be averaged, and the correlation coefficient Γ(λ) of the frame signal of the λth frame of the first voice signal and the frame signal of the λth frame of the second voice signal can be obtained.

It should be understood by those skilled in the art that, in order to make the correlation coefficient Γ(λ) of the frame signal of the λth frame of the first voice signal and the frame signal of the λth frame of the second voice signal more accurate, Γ(λ) may be further smoothed, and the specific implementation is not further introduced in this embodiment.

It should be understood by those skilled in the art that there are many calculation formulas for calculating the correlation between two signals, and the above formula is only taken as an example, and those skilled in the art can select a corresponding formula to calculate the correlation of two voice signals according to actual situations.

From the correlation between the voice signals, a state of the current frame can be determined.

In some embodiments, if the correlation of the frame signal of the λth frame of the first voice signal and the frame signal of the λth frame of the second voice signal is greater than the first threshold, it indicates that the frame signal of the λth frame of the second voice signal is a signal output by the wearer, and the state of the current frame may be set to 1. If the correlation of the frame signal of the λth frame of the first voice signal and the frame signal of the λth frame of the second voice signal is less than or equal to the first threshold, it indicates that the frame signal of the λth frame of the second voice signal is not a signal output by the wearer, and the state of the current frame may be set to 0.

The first threshold is, for example, 0.5, and it should be understood by those skilled in the art that the value of the first threshold here is only taken as an example, and the value of the first threshold may further be adjusted according to the actual situation, for example, the accuracy requirement. For example, if the accuracy requirement is high, the value of the first threshold is increased, for example, 0.6, 0.7, 0.8, 0.9, and the like. If the accuracy requirement is not high, the value of the first threshold is decreased, for example, 0.3, 0.4, 0.45, and the like.

In a real-time interactive scenario, voice is processed in unit of frame, but the processing result of a single frame signal may fluctuate. Therefore, in some embodiments of the present disclosure, the calculated correlation between the first voice signal and the second voice signal is smoothed to improve the stability of the judgment result. This will be introduced below by taking FIG. 3 as an example.

FIG. 3 illustrates a flow diagram for controlling the wearable device according to some embodiments of the present disclosure, which further introduce step S14 in FIG. 1, wherein step S14 includes step S141 and step S142. Only differences between FIG. 3 and FIG. 1 will be described below, and the same parts will not be repeated.

In step S141, determining the number of frames in multiple frame signals of the first voice signal, whose correlations with the corresponding frame signals of the second voice signal are greater than the first threshold.

For example, with respect to consecutive multiple frame signals, since the correlation between the single frame signal of the first voice signal and the corresponding frame signal of the second voice signal at the same moment has been calculated, it is possible to make a judgement on the consecutive multiple frame signals, that is, to determine the number of frames in the multiple frame signals of the first voice signal, whose correlations with the corresponding frame signals of the second voice signal are greater than the first threshold.

In some embodiments, the number of multiple frame signals is determined according to a control latency requirement of the wearable device.

For example, when the wearable device is controlled, although the multiple frame signals are smoothed, the delay after smoothing must be lower than the control latency requirement of the device end, so that the stability is balanced on the one hand, and the user experience is improved on the other hand, reducing the occurrence of situations that the delay is too long and the user experience is poor due to too much pursuit of the stability.

In some embodiments, the multiple frame signals are, for example, 6 frame signals, i.e., smoothing is performed once for every 6 frame signals. It should be understood by those skilled in the art that the value of the number of frame signals is only taken as an example, and the number of frame signals for smoothing may be determined according to an actual situation.

In step S142, in response to the number of frames being greater than a second threshold and the second voice signal contains a control instruction, controlling the wearable device.

For example, if the number of frames in the multiple frame signals of the first voice signal, whose correlations with the corresponding frame signals of the second voice signal are greater than the first threshold, is greater than the second threshold, it indicates that the wearer of the wearable device is speaking. If the second voice signal contains the control instruction, the wearable device can be controlled.

The setting of the second threshold is related to the number of multiple frame signals. Those skilled in the art will appreciate that the value of the second threshold may be adjusted according to the accuracy or stability requirement. For example, if the accuracy or stability requirement is high, the value of the second threshold is increased. If the accuracy or stability requirement is not high, the value of the second threshold is decreased.

For another example, it may also be judged whether in the multiple frame signals of the first voice signal, there are a predetermined proportion of frame signals whose correlations with the corresponding frame signals of the second voice signal are greater than the first threshold. It will be understood by those skilled in the art that, the judgement as to whether in the multiple frame signals of the first voice signal, there are the predetermined proportion of frame signals whose correlations with corresponding frame signals of the second voice signal are greater than the first threshold, may be converted equally to the judgement as to whether in the multiple frame signals of the first voice signal, the number of frames whose correlations with the corresponding frame signals of the second voice signal are greater than the first threshold, is greater than the second threshold.

If in the multiple frame signals of the first voice signal, there are the predetermined proportion of frame signals whose correlations with the corresponding frame signals of the second voice signal are greater than the first threshold, it indicates that the wearer of the wearable device is speaking. If the second voice signal contains the control instruction, the wearable device can be controlled.

For another example, taking the state of the frame as an example, if the correlation of the single frame signal of the first voice signal and the corresponding frame signal in the second voice signal is greater than the first threshold, the state of the current frame is 1. If the correlation of the single frame signal of the first voice signal and the corresponding frame signal in the second voice signal is less than or equal to the first threshold, the state of the current frame is 0. By adding the detection results of the states of the multiple frame signals, if the addition result is greater than a certain threshold, it indicates that the wearer of the wearable device is speaking, and if the second voice signal contains the control instruction, the wearable device can be controlled.

In the above embodiment, by determining the correlation between the single frame signal of the first voice signal and the corresponding frame signal of the second voice signal at the same moment, it can be determined whether the wearer of the wearable device is speaking at the moment corresponding to the current frame, and then the judgment results of the multiple frame signals are smoothed, which may reduce the situation of false control due to the instability of the single frame processing result, improve the robustness and stability of the judgment of the speaking state of the wearer, and further improve the stability of control of the wearable device.

In some embodiments, the control instruction is, for example, a wake up instruction. Through the judgment of the correlation, whether the wearable device is to be awakened can be recognized in time, reducing the interference of another non-wearer on the awakening of the wearable device, and improving the user experience of the wearer.

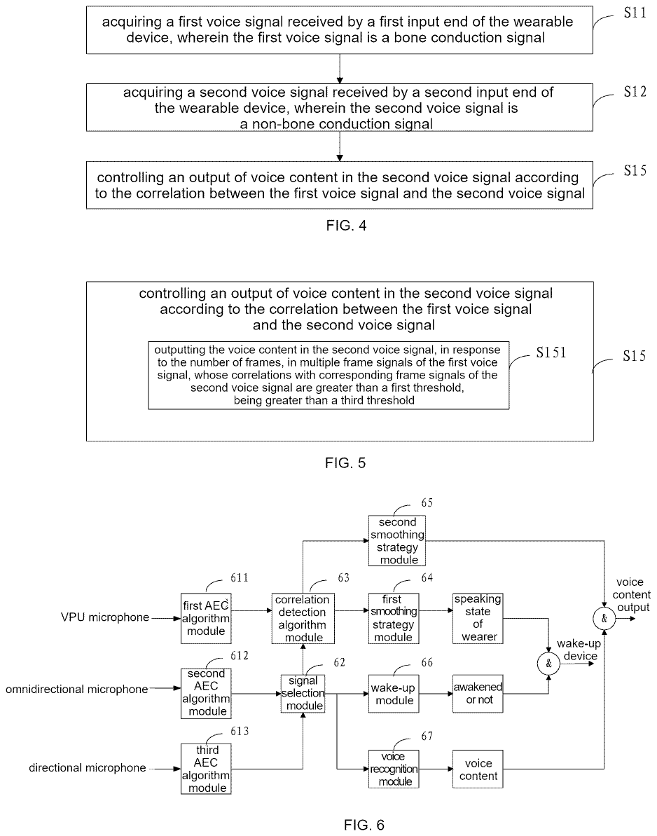

In real life, the wearer may interact by voice with another device or application through the wearable device, and may also be disturbed by a non-wearer during the voice interaction. The method for controlling the wearable device will be further described with reference to FIG. 4.

FIG. 4 illustrates a flow diagram of the method for controlling the wearable device according to still some embodiments of the present disclosure, which includes step S15 in addition to steps S11-S13. Only the differences between FIG. 4 and FIG. 1 will be described below, and the same parts will not be repeated.

In step S15, an output of voice content in the second voice signal is controlled according to the correlation between the first voice signal and the second voice signal.

For example, the voice recognition is performed on the voice content in the second voice signal. The voice recognition process can be performed in cloud, thereby reducing the consumption of the local device resource. Of course, the voice recognition process may alternatively be performed locally if the local resource is sufficient, e.g., the controller of the wearable device has sufficient computational power.

The voice recognition algorithm is not limited in the embodiment and those skilled in the art can recognize the content in the second voice signal using the voice recognition algorithm in the related art.

If the correlation between the first voice signal and the second voice signal is greater than the first threshold, it indicates that the wearer of the wearable device is speaking, and at this time, the output of the voice content in the second voice signal may be controlled. For example, the voice content is displayed in an application.

In the above embodiment, by using the correlation between the two types of voice signals, even if the energy of the bone conduction signal is low, it can still recognized whether the voice content is the voice content output by the wearer of the wearable device, so that the accuracy of the voice interaction is improved.

In a real-time interactive scenario, voice is processed in unit of frame, but the processing result of a single frame signal may fluctuate. Therefore, in some embodiments of the present disclosure, the calculated correlations between the first voice signal and the second voice signal are smoothed to improve the stability of the recognition and output of the voice content. Step S15 will be further described below with reference to FIG. 5.

FIG. 5 illustrates a flow diagram of controlling the output of the voice content in the second voice signal according to some embodiments of the present disclosure, and step S15 includes step S151. Only the differences between FIG. 5 and FIG. 1 will be described below, and the same parts will not be repeated.

In step 151, in response to the number of frames, in the multiple frame signals of the first voice signal, whose correlations with the corresponding frame signals of the second voice signal are greater than the first threshold, being greater than a third threshold, outputting the voice content in the second voice signal.

The step of determining the number of frames, in the multiple frame signals of the first voice signal, whose correlations with the corresponding frame signals of the second voice signal are greater than the first threshold may be performed in cloud or locally.

In some embodiments, the number of multiple frame signals is determined according to the voice recognition latency requirement of the cloud corresponding to the wearable device.

For example, when the wearer interacts with a certain application through the wearable device, although the multiple frame signals are smoothed, delay after smoothing is lower than the voice recognition latency requirement of the cloud, so that the stability is balanced on the one hand, the latency requirement is balanced on the other hand, improving the user experience, and reducing the occurrence of the situation that the delay is too long and the user experience is poor due to too much pursuit of stability.

For example, since the delay of the voice recognition itself is relatively large, 50 frame signals may be used for one smoothing process, and it should be understood by those skilled in the art that the value of the number of multiple frame signals is only used as an example, and may be set according to an actual situation.

If the number of frames, in the multiple frame signals of the first voice signal, whose correlations with the corresponding frame signals of the second voice signal are greater than the first threshold, is greater than the third threshold, it indicates that the wearer of the wearable device is speaking, and the voice content recognized by the voice recognition module may be output.

The third threshold is set in relation to the number of multiple frame signals. Those skilled in the art will appreciate that the value of the third threshold may be adjusted according to the accuracy or stability requirement. For example, if the accuracy or stability requirement is high, the value of the third threshold is increased. If the accuracy or stability requirement is not high, the value of the third threshold is decreased.

For another example, if in the multiple frame signals of the first voice signal, there are a predetermined proportion of frame signals whose correlations with the corresponding frame signals of the second voice signal are greater than the first threshold, it indicates that the wearer of the wearable device is speaking, and the voice content recognized by the voice recognition module may be output.

It should be understood by those skilled in the art that, the judgement in the embodiment using the predetermined ratio of frame signals and the judgement in the previous embodiment using the number of frames can be converted relatively.

For another example, taking the state of the frame as an example, if the correlation between a single frame signal of the first voice signal and a corresponding frame signal in the second voice signal is greater than the first threshold, the state of the current frame is 1. If the correlation between the single frame signal of the first voice signal and the corresponding frame signal in the second voice signal is less than or equal to the first threshold, the state of the current frame is 0. By adding the detection results of the states of the multiple frame signals, if the addition result is greater than a certain threshold, it indicates that the wearer of the wearable device is speaking, and further the voice content recognized by the voice recognition module may be output. For example, taking the example of smoothing 50 frame signals once, the state detection results of the 50 frames are added, and if the added value is greater than 24, it is believed that the wearer is speaking.

In the above embodiment, by calculating the correlation between the single frame signal of the first voice signal and the corresponding frame signal of the second voice signal at the same moment, it can be determined whether the wearer of the wearable device at the moment corresponding to the current frame is speaking, and then the judgment results of the multiple frame signals are smoothed, so that the situation of false output caused by the unstable single frame processing result can be reduced, the robustness and stability of the judgment of the speaking state of the wearer is improved, and further the accuracy of the voice content output is improved.

In order to improve the accuracy of the voice recognition, a time point of a first word and a time point of a last word in the second voice signal may be recognized first, so that only the voice content between the first word and the last word is output. In some embodiments, the time point of the first word and the time point of the last word in the second voice signal are determined according to the correlations with the corresponding frame signals of the second voice signal, in the multiple frame signals of the first voice signal.

For example, the cloud determines the time point of the first word and the time point of the last word in the second voice signal according to the correlation between the first voice signal and the second voice signal, and assists in recognizing the voice content output by the wearer according to the time point of the first word and the time point of the last word.

The time point of the first word is a coordinate of the first word, and the time point of the last word is a coordinate of the last word. For example, according to the correlation between the frame signals, it can be determined when the wearer starts speaking and stops speaking, so that the time point of the first word and the time point of the last word in the wearer voice signal are used for recognizing the first word and the last word in the second voice signal, reducing the interference, and improving the accuracy of the voice content recognition.

To improve the stability of the link, in some embodiments, the method for controlling the wearable device further includes: ending the output of the voice content in response to a current time point being earlier than the time point of the last word in the second voice signal by more than a time threshold.

For example, for the judgment of the speaking end state of the wearer, it may be recognized whether the time point of the last word in the second voice signal is more than 500 ms (millisecond) from the current time, that is, if it is detected that the wearer is not speaking during 500 ms, then it is judged that speaking is end, thereby ending the output of the voice content, which may make the interactive link more stable.

The method for controlling the wearable device of the present disclosure will be described in combination with a specific embodiment.

As shown in FIG. 6, which illustrates a link diagram of the method for controlling the wearable device according to some embodiments of the present disclosure, wherein the wearable device includes three microphones, e.g., the VPU microphone, the omnidirectional microphone, and the directional microphone.

The bone conduction signal received by the VPU microphone is AEC processed by a first AEC algorithm module 611 to obtain the bone conduction signal from which the acoustic echo is cancelled. The first signal received by the omnidirectional microphone is AEC processed by a second AEC algorithm module 612 to obtain the first signal from which the acoustic echo is cancelled. The second signal received by the directional microphone is AEC processed by a third AEC algorithm module 613 to obtain the second signal from which the acoustic echo is cancelled.

A signal selection module 62 is used to select from the first signal from which the acoustic echo is cancelled and the second signal from which the acoustic echo is cancelled, so as to obtain a selection signal. A correlation detection algorithm module 63 is used to calculate the correlation between a single frame signal of the bone conduction signal from which the acoustic echo is cancelled and a corresponding frame signal of the selection signal at the same moment. For example, if the correlation is greater than 0.5, it is determined that the state of the current frame signal is 1, that is, the speaking state of the wearer is 1; if the correlation is less than or equal to 0.5, the state of the current frame signal is determined to be 0, that is, the speaking state of the wearer is 0.

Since there is a fluctuation in the judgment of the speaking state of the wearer by taking frame as unit, which results in the instability of the judgment result, the state detection results can be subsequently smoothed from the device end and the cloud respectively.

For example, a first smoothing strategy module 64 is used to sum the states of the multiple frame signals to recognize the speaking state of the wearer, i.e., whether the wearer is speaking. For example, once smoothing is performed on 6 frame signals, and if the sum of the state detection results of the 6 frame signals is greater than 2, it is believed that the wearer is speaking. The first smoothing strategy module 64 is located on the device end.

For another example, a second smoothing strategy module 65 is used to sum the states of the multiple frame signals to recognize the speaking state of the wearer, i.e., whether the wearer is speaking. For example, once smoothing is performed on 60 frame signals, and if the sum of the state detection results of the 60 frame signals is greater than 24, it is believed that the wearer is speaking. The second smoothing strategy module 65 is located in the cloud.

The cloud and the device end have different requirements on the latency, thus the smoothing strategies are different, but the delay from smoothing on the end is lower than the delay of awakening on the end, and the delay from smoothing on the cloud is lower than the delay from recognizing result on the cloud.

The selection signal output by the signal selection module 62 is processed through two links respectively. For example, a wake-up module 66 in a voice wake-up link recognizes whether the selection signal contains a wake-up instruction. If the selection signal includes a wake-up state and the wearer is identified as speaking by the first smoothing strategy module 64, the wearable device is awakened. After awaking the wearable device, the voice content is recognized by a voice recognition module 67 in a voice recognition link. If the wearer is identified as speaking by the second smoothing strategy module 65, the voice content is output. The voice recognition link is a cloud processing link.

In the above embodiment, the speaking state of the wearer of the wearable device is detected using the microphone and the software processing module in combination with software and hardware. The speaking state of the wearer is recognized by utilizing the correlation between the two types of voice signals, and different state detection smoothing strategies are designed for the on-end and cloud links, so that the whole speaking state result judgment has more robustness and stability, realizing the voice interaction function targeted at the wearer.

It may be understood by those skilled in the art that, in the above methods of the specific embodiments, the order of the steps does not imply a strict order of execution and does not impose any limitations on the implementations, as the specific order of execution of the steps should be determined by their functions and possible inherent logic.

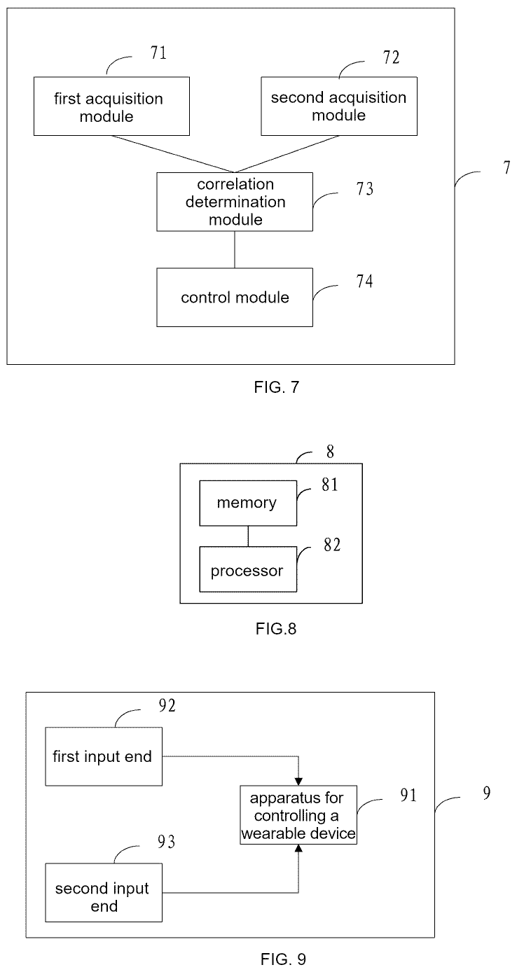

The foregoing is the method for controlling the wearable device according to some embodiments of the present disclosure. An apparatus for controlling a wearable device in some embodiments of the present disclosure will be described below in conjunction with FIG. 7.

FIG. 7 illustrates a block diagram of the apparatus for controlling the wearable device according to some embodiments of the present disclosure, and as shown in FIG. 7, the apparatus 7 for controlling the wearable device includes a first acquisition module 71, a second acquisition module 72, a correlation determination module 73, and a control module 74.

The first acquisition module 71 is configured to acquire a first voice signal received by a first input end of the wearable device, wherein the first voice signal is a bone conduction signal; the second acquisition module 72 is configured to acquire a second voice signal received by a second input end of the wearable device, wherein the second voice signal is a non-bone conduction signal; the correlation determination module 73 is configured to determine a correlation between the first voice signal and the second voice signal; and the control module 74 is configured to control the wearable device according to the correlation between the first voice signal and the second voice signal, and the second voice signal.

The apparatus for controlling the wearable device may be a controller arranged on the wearable device, and may also include a control, calculation component located in the cloud. The apparatus for controlling the wearable device may be used to perform steps S11 through S14 of FIG. 1.

The apparatus for controlling the wearable device can still recognize whether the wearer of the wearable device is speaking by utilizing the correlation between the two types of voice signals even if the energy of the bone conduction signal is low, reducing the occurrence of false control of the device due to the inaccuracy of the recognition of a single type of voice signal.

In some embodiments, the first input end is the VPU microphone.

In some embodiments, the second input end is one of the directional microphone and the omnidirectional microphone that receives a voice signal with lower energy, thereby reducing the noise in the second voice signal.

In some embodiments, the correlation determination module 73 is configured to determine a correlation between a single frame signal of the first voice signal and a corresponding frame signal of the second voice signal at the same moment.

If the correlation between the current frame signal of the first voice signal and the current frame signal of the second voice signal is greater than the first threshold, it indicates that the current frame signal of the second voice signal is an signal output by the wearer. If the correlation between the current frame signal of the first voice signal and the current frame signal of the second voice signal is less than or equal to the first threshold, it indicates that the current frame signal of the second voice signal is not the signal output by the wearer.

In some embodiments, the control module 74 is configured to determine the number of frames, in multiple frame signals of the first voice signal, whose correlations with corresponding frame signals of the second voice signal are greater than the first threshold; and in response to the number of frames being greater than a second threshold and the second voice signal containing a control instruction, to control the wearable device.

In a real-time interactive scene, voice is processed in unit of frame, but the processing result of a single frame signal is instable and fluctuates. Therefore, in this embodiment, the calculated correlation between the first voice signal and the second voice signal is smoothed, so as to improve the stability of the judgement result.

In some embodiments, the number of multiple frame signals is determined according to a control latency requirement of the wearable device. The embodiment can balance the stability of judgment and the time latency requirement, thereby improving the user experience.

In some embodiments, the control instruction includes a wake-up instruction, thereby enabling a wake-up operation on the wearable device.

In some embodiments, the control module 74 is further configured to control an output of voice content in the second voice signal according to the correlation between the first voice signal and the second voice signal.

For example, if the correlation between the first voice signal and the second voice signal is greater than the first threshold, it indicates that the wearer of the wearable device is speaking, and at this time, the output of the voice content in the second voice signal may be controlled.

In the above embodiment, by utilizing the correlation between the two types of voice signals, it can be still recognized whether the wearer of the wearable device is speaking even if the energy of the bone conduction signal is low, thereby improving the accuracy of voice interaction.

In some embodiments, the control module 74 is further configured to output the voice content in the second voice signal, in response to the number of frames, in the multiple frame signals of the first voice signal, whose correlations with corresponding frame signals of the second voice signal are greater than the first threshold being greater than a third threshold.

In the above embodiment, by calculating the correlation between the single frame signal of the first voice signal and the corresponding frame signal of the second voice signal at the same moment, it can be determined whether the wearer of the wearable device at the moment corresponding to the current frame is speaking, and then the judgment results of the multiple frame signals are smoothed, so that the situation of false output due to instability of single frame processing result can be reduced, the robustness and stability of judgment of the speaking state of the wearer is improved, and further the accuracy of voice content output is improved.

In some embodiments, the number of multiple frame signals is determined according to the voice recognition latency requirement of the cloud corresponding to the wearable device. The embodiment can balance the stability of judgment and the latency requirement, thereby improving the user experience.

In some embodiments, the time point of the first word and the time point of the last word in the second voice signal are determined according to the correlations with the corresponding frame signals of the second voice signal, in the multiple frame signals of the first voice signal.

The time point of the first word is the coordinate of the first word, and the time point of the last word is the coordinate of the last word. For example, according to the correlation between the frame signals, it can be determined when the wearer starts speaking and stops speaking, so that the first word time point and the last word time point in the wearer voice signal are used for recognizing the first word and the last word in the second voice signal, reducing the interference, and improving the accuracy of voice content recognition.

In some embodiments, the control module 74 is further configured to end the output of the voice content in response to the current time point being earlier than the time point of the last word in the second voice signal by more than the time threshold.

It should be noted that the above units are only logic modules divided according to the specific functions implemented thereby, and are not used for limiting the specific implementation, and may be implemented in software, hardware or a combination of software and hardware, for example. In actual implementation, the above units may be implemented as independent physical entities, or may alternatively be implemented by a single entity (for example, a processor (CPU or DSP, etc.), an integrated circuit, etc.). Furthermore, the above units described above are shown in dashed lines in the figures to indicate that these units may not actually be present, but that the operations/functions they implement may be implemented by processing circuitry itself.

The foregoing description of the various embodiments is intended to highlight differences between the various embodiments, and the same or similar parts thereof may be referenced one another, and for the sake of brevity, they are not repeated in this disclosure.

The present disclosure further provides an apparatus for controlling a wearable device, described below in conjunction with FIG. 8.

FIG. 8 illustrates a block diagram of the apparatus for controlling the wearable device according to some other embodiments of the present disclosure. As shown in FIG. 8, the apparatus 8 for controlling the wearable device includes a memory 81 and a processor 82 coupled to said memory. The processor 82 is configured to perform the method for controlling the wearable device of any of the embodiments described above based on instructions stored in the memory.

The memory 81 is used to store one or more computer readable instructions. The memory 81 may include any combination of various forms of computer readable storage media, such as volatile memory and/or nonvolatile memory, including but not limited to Random Access Memory (RAM), Dynamic Random Access Memory (DRAM), Static Random Access Memory (SRAM), Read Only Memory (ROM), flash memory. The memory 81 may store, for example, an operating system, an application, a Boot Loader, a database, and other programs, and may store various applications, various data, and the like.

The processor 82 is used to execute computer readable instructions to implement the method for controlling the wearable device according to any of the foregoing embodiments or the method according to any of the foregoing embodiments. For the specific implementation of each step of the method, reference may be made to the above-described embodiments, and the repetition part is not described herein again.

The processor 82 may be configured to perform the steps of FIGS. 1-6. The processor 82 may be embodied as various processing means such as a Central Processing Unit (CPU), Network Processor (NP), or the like; but may also be a Digital Signal Processor (DSP), an Application Specific Integrated Circuit (ASIC), a Field Programmable Gate Array (FPGA) or other programmable logic device, discrete gate or transistor logic, discrete hardware components. The Central Processing Unit (CPU) may be an X86 or ARM architecture, etc.

The processor 82 and the memory 81 may be in direct or indirect communication with each other. For example, the processor 82 and the memory 81 may communicate over a network. The network may include a wireless network, a wired network, and/or any combination of wireless and wired networks. The processor 82 and the memory 81 may also communicate with each other via a system bus, which is not limited by the present disclosure.

It should be noted that the components of the apparatus 8 for controlling the wearable device shown in FIG. 8 are only exemplary and not restrictive, and the apparatus 8 for controlling the wearable device may have other components according to an actual application. The processor 82 may control other components in the apparatus 8 for controlling the wearable device to perform desired functions.

The apparatus for controlling the wearable device may be implemented in software, firmware and/or hardware, and may be integrated in an apparatus installed with associated applications.

FIG. 9 illustrates a block diagram of a wearable device according to some embodiments of the present disclosure, and as shown in FIG. 9, the wearable device 9 includes the apparatus 91 for controlling the wearable device in the above embodiment, and a first input end 92 and a second input end 93.

The apparatus 91 for controlling the wearable device may be the apparatus 7 for controlling the wearable device in FIG. 7, or may be the apparatus 8 for controlling the wearable device in FIG. 8. The apparatus 91 for controlling the wearable device has been described in detail in the above embodiments, and will not be further described here. The first input end 92 is configured to receive the first voice signal, wherein the first voice signal is the bone conduction signal. The second input end 93 is configured to receive the second voice signal, wherein the second voice signal is the non-bone conduction signal.

In some embodiments, the second input end 93 is one of a directional microphone and a omnidirectional microphone, which receives a voice signal with lower energy.

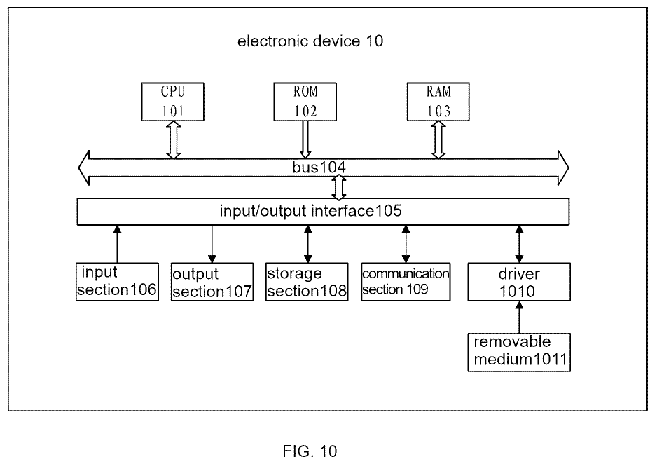

FIG. 10 illustrates a block diagram of an electronic device according to some embodiments of the present disclosure. The apparatus for controlling the wearable device presents in the form of an electronic device.

The electronic device 10 shown in FIG. 10 may be a computer system with a dedicated hardware structure, and when an associated application is installed, can perform a corresponding function.

The electronic device includes, but is not limited to, a mobile terminal such as a smart phone, notebook computer, Personal Digital Assistant (PDA), Tablet Personal Computer (Tablet PC), PMP (portable multimedia player), in-vehicle terminal (e.g., in-vehicle navigation terminal), wearable device, and the like, and a fixed terminal such as a digital TV, desktop computer, and the like.

As shown in FIG. 10, a central processing unit (CPU) 101 executes various processes in accordance with a program stored in a Read Only Memory (ROM) 102 or a program loaded from a storage section 108 to a Random Access Memory (RAM) 103. In the RAM 103, data necessary when the CPU 101 executes various processes and the like is stored as necessary. The central processing unit is merely exemplary and may be other types of processors such as the various processors described above. The ROM 102, RAM 103, and storage section 108 may be various forms of computer readable storage media. It is noted that although ROM 102, RAM 103, and storage section 108 are shown separately in FIG. 10, one or more of them may be combined or located in the same or different memory or storage modules.

The CPU 101, ROM 102, and RAM 103 are connected to each other via a bus 104. An input/output interface 105 is also connected to the bus 104.

The following components are connected to the input/output interface 105: an input section 106 such as a touch screen, a touch pad, a keyboard, a mouse, an image sensor, a microphone, an accelerometer, a gyroscope, or the like; an output section 107 including a display such as a Cathode Ray Tube (CRT), a Liquid Crystal Display (LCD), a speaker, a vibrator, or the like; the storage section 108 including a hard disk, a magnetic tape, and the like; and a communication section 109 including a network interface card such as a LAN card, a modem, and the like. The communication section 109 allows communication processing to be performed via a network such as the Internet. It will be readily appreciated that although the sections of the electronic device 10 shown in FIG. 10 are shown as communicating via the bus 104, they may also communicate via a network or otherwise, wherein the network may include a wireless network, a wired network, and/or any combination of wireless and wired networks.

A driver 1010 is also connected to the input/output interface 105 as necessary. A removable medium 1011 such as a magnetic disk, an optical disk, a magneto-optical disk, a semiconductor memory, or the like is mounted on the driver 1010 as needed, so that a computer program read out therefrom is installed into the storage section 108 as needed.

When the series of processes is implemented by software, a program constituting the software may be installed from a network such as the Internet or a storage medium such as the removable medium 1011.

According to embodiments of the present disclosure, the processes described above with reference to the flow diagrams may be implemented as a computer software program. For example, some embodiments of the present disclosure include a computer program product which, when run on a computer, causes the computer to implement the method of any of the preceding embodiments. The computer program product includes computer instructions carried on a computer readable medium, containing program codes for performing the method illustrated by the flow diagram. In such an embodiment, the computer instructions may be downloaded and installed from a network through the communication section 109, or installed from the storage section 108, or installed from the ROM 102. When the computer program is executed by the CPU 101, the methods of the embodiments of the present disclosure are performed.

In the context of this disclosure, the computer readable medium may be any tangible medium that can contain, or store a program for use by or in connection with an instruction execution system, apparatus, or device.

The computer readable medium may be a non-transitory computer readable storage medium or a computer readable signal medium, or any combination of above two.

The computer readable storage media include, but are not limited to: an electronic, magnetic, optical, electromagnetic, infrared, or semiconductor system, apparatus, or device, or any combination of the foregoing. More specific examples of the computer readable storage medium may include, but are not limited to: an electrical connection with one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. The computer readable storage medium has stored thereon computer instructions which, when executed by a processor, implement the method of any of the preceding embodiments.

The computer readable signal medium may include a propagated data signal with computer readable program code carried therein, for example, in baseband or as part of a carrier wave. Such a propagated data signal may take any of a variety of forms, including, but not limited to, electro-magnetic signal, optical signal, or any suitable combination thereof. The computer readable signal medium may be any computer readable medium that is not a computer readable storage medium and that can transmit, propagate, or transport a program for use by or in connection with an instruction execution system, apparatus, or device. Program codes contained on the computer readable medium may be transmitted using any appropriate medium, including but not limited to: electrical wires, optical cables, RF (radio frequency), etc., or any suitable combination of the foregoing.

The computer readable medium may be contained in the above electronic device; or may be separate and not assembled into the electronic device.

In some embodiments, there is also provided a computer program comprising: instructions that when executed by a processor, cause the processor to perform the method for controlling the wearable device as described in any of the preceding embodiments. For example, the instructions may be embodied as computer program codes. In the embodiments of the present disclosure, computer program codes for carrying out operations of the present disclosure may be written in one or more programming languages or the combination thereof, including but not limited to an object oriented programming language such as Java, Smalltalk, C++, including conventional procedural programming languages, such as the “C” language or similar programming languages. The program codes may be executed entirely on the user's computer, partly on the user's computer, as a stand-alone software package, partly on the user's computer and partly on a remote computer or entirely on the remote computer or server. In the scenario where the remote computer is involved, the remote computer may be connected to the user's computer through any type of network, including a Local Area Network (LAN) or a Wide Area Network (WAN), or may be connected to an external computer (for example, through the Internet using an Internet service provider).

The flow and block diagrams in the figures illustrate the architecture, functionality, and operation of possible implementations of systems, methods and computer program products according to various embodiments of the present disclosure. In this regard, each block in the flow or block diagrams may represent a module, a program segment, or a portion of the codes, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionality involved. It will also be noted that each block of the block and/or flow diagrams, and combinations of blocks in the block and/or flow diagrams, can be implemented by special purpose hardware-based systems that perform the specified functions or actions, or combinations of special purpose hardware and computer instructions.

The functions described above may be performed, at least in part, by one or more hardware logic components. For example, without limitation, exemplary hardware logic components that may be used include: field Programmable Gate Array (FPGA), Application Specific Integrated Circuit (ASIC), Application Specific Standard Product (ASSP), system on a chip (SOC), Complex Programmable Logic Device (CPLD), and the like.

Although some specific embodiments of the present disclosure have been described in detail by way of example, it should be understood by those skilled in the art that the above examples are for illustration only and are not intended to limit the scope of the present disclosure. It will be appreciated by those skilled in the art that modifications can be made to the above embodiments without departing from the scope and spirit of the present disclosure. The scope of the present disclosure is defined by the appended claims.

1. A method for controlling a wearable device, comprising:
acquiring a first voice signal received by a first input end of the wearable device, wherein the first voice signal is a bone conduction signal;
acquiring a second voice signal received by a second input end of the wearable device, wherein the second voice signal is a non-bone conduction signal;
determining a correlation between the first voice signal and the second voice signal; and
controlling the wearable device according to the second voice signal and the correlation between the first voice signal and the second voice signal.

2. The method for controlling the wearable device according to claim 1, wherein determining the correlation between the first voice signal and the second voice signal comprises:
determining a correlation between a single frame signal of the first voice signal and a corresponding frame signal of the second voice signal at a same moment.

3. The method for controlling the wearable device according to claim 2, wherein controlling the wearable device according to the second voice signal and the correlation between the first voice signal and the second voice signal comprises:
determining a number of frames, in multiple frame signals of the first voice signal, whose correlations with corresponding frame signals of the second voice signal are greater than a first threshold; and
controlling the wearable device, in response to the number of frames being greater than a second threshold and the second voice signal containing a control instruction.

4. The method for controlling the wearable device according to claim 3, wherein a number of multiple frame signals is determined according to a control latency requirement of the wearable device.

5. The method for controlling the wearable device according to claim 2, further comprising:
controlling an output of voice content in the second voice signal according to the correlation between the first voice signal and the second voice signal.

6. The method for controlling the wearable device according to claim 5, wherein controlling the output of the voice content in the second voice signal according to the correlation between the first voice signal and the second voice signal comprises:
outputting the voice content in the second voice signal, in response to a number of frames, in multiple frame signals of the first voice signal, whose correlations with corresponding frame signals of the second voice signal are greater than a first threshold, being greater than a third threshold.

7. The method for controlling the wearable device according to claim 6, wherein a number of multiple frame signals is determined according to a voice recognition latency requirement of a cloud corresponding to the wearable device.

8. The method for controlling the wearable device according to claim 5, wherein,
a time point of a first word and a time point of a last word in the second voice signal are determined according to correlations with corresponding frame signals of the second voice signal, in multiple frame signals of the first voice signal.

9. The method for controlling the wearable device according to claim 8, further comprising:
ending the output of the voice content, in response to a current time point being earlier than the time point of the last word in the second voice signal by more than a time threshold.

10. The method for controlling the wearable device according to claim 1, wherein the second input end is one of a directional microphone and an omnidirectional microphone, which receives a voice signal with lower energy.

11. The method for controlling the wearable device according to claim 3, wherein the control instruction contains a wake-up instruction.

12. The method for controlling the wearable device according to claim 1, further comprising:
performing acoustic echo cancellation processing on the first voice signal and the second voice signal, prior to determining the correlation between the first voice signal and the second voice signal.

13. An apparatus for controlling a wearable device, comprising:
a first acquisition module configured to acquire a first voice signal received by a first input end of the wearable device, wherein the first voice signal is a bone conduction signal;
a second acquisition module configured to acquire a second voice signal received by a second input end of the wearable device, wherein the second voice signal is a non-bone conduction signal;
a correlation determination module configured to determine a correlation between the first voice signal and the second voice signal; and
a control module configured to control the wearable device according to the second voice signal and the correlation between the first voice signal and the second voice signal.

14. An apparatus for controlling a wearable device, comprising:
a memory; and
a processor coupled to the memory, the processor configured to perform the method for controlling the wearable device according to claim 1, based on instructions stored in the memory.

15. A wearable device, comprising:
the apparatus for controlling the wearable device according to claim 13;
a first input end configured to receive a first voice signal, wherein the first voice signal is a bone conduction signal; and
a second input end configured to receive a second voice signal, wherein the second voice signal is a non-bone conduction signal.

16. A wearable device, comprising:
the apparatus for controlling the wearable device according to claim 14;
a first input end configured to receive a first voice signal, wherein the first voice signal is a bone conduction signal; and
a second input end configured to receive a second voice signal, wherein the second voice signal is a non-bone conduction signal.

17. A non-transitory computer readable storage medium having computer program instructions stored thereon which, when executed by a processor, implementing the method for controlling the wearable device according to claim 1.
